(19) United States
(12) Patent Application Publication
(10) Pub. No.: US 2005/0234720 A1
(43) Pub. Date: Oct. 20, 2005

(54) Voice application system

(76) Inventors: Eric Paillet, Tregastel (FR); Dominique Dubois, Pleumeur-Bodou (FR); Danielle Larreur, Trebeurden (FR)

Correspondence Address: YOUNG & THOMPSON, 745 SOUTH 23RD STREET, 2ND FLOOR, ARLINGTON, VA, 22202, US

(21) Appl. No.: 11/097,210

(22) Filed: Apr. 4, 2005

(30) Foreign Application Priority Data
Apr. 2, 2004 (FR) 0403511

(51) Int. Cl. G10L 15/04

(52) U.S. Cl. 704/251

(57) ABSTRACT

A voice application system includes elements for acquiring at least one phrase spoken by at least one user connected to semantic analysis element including members for recognizing keywords belonging to the phrase stated and capable of generating an ordered list of keywords, called a listing, for the phrase spoken, the recognition members being connected to elements providing an association in the form of rules between at least one predetermined keyword and a specific action and elements for selecting at least one particular action when a set of keywords included in the corresponding rule are present in the phrase stated. The selection elements run through the set of rules for the purposes of identification and for each given rule search for the presence of a set of keywords for that rule in the phrase stated in order to select the corresponding specific action relating to the rule so determined and identified.

### BACKGROUND OF THE INVENTION

This invention relates to automatic voice recognition systems which are capable of initiating an action in relation to a phrase spoken by a user.

Such systems are in particular used in the voice servers of telecommunications systems.

These voice servers are used within interactive voice applications in which a dialogue is entered into between a user and an automatic system in order to establish the expectations of that user.

They comprise a voice recognition system which provides an unprocessed phrase spoken by the user and a semantic analysis system which breaks down the phrase into a sequence of keywords. Furthermore the latter has a set of rules which associate a set of keywords with an action which has to be executed. The semantic analyser then seeks out the rule or rules for which the expected keywords are found in the phrase spoken by the user.

If several rules are selected in this way, the semantic analyser selects the most pertinent rule using criteria such as a probabilistic weighting, the context in which the phrase was spoken, etc.

Once the rule has been selected, the action which it specifies is executed by a dialogue management system. In voice servers the action frequently corresponds to the generation of a prerecorded phrase providing the reply expected by the user or asking a question in order to better determine the latter's expectations.

The techniques currently used by semantic analysers operate on the basis of a strict correspondence between the words found in the listing and the expected words in the rule.

Thus when a keyword is present in the listing, even if it is not the determining one for the general meaning, it must be found in the rule in order for the latter to be accepted.

Now this type of operation is not very well suited to the phrases normally encountered in oral exchanges, in particular because these phrases are subject to noise, are grammatically incorrect, poorly constructed, and often include hesitation or redundant information which was not envisaged when the rules were written.

This extreme sensitivity then makes it necessary for the designer to write all possible rules in relation to all syntax errors imaginable.

This inconvenience thus greatly restricts the use of such systems.

The object of the invention is therefore to provide a voice application system which can easily recognise the applicable rules despite noise and imperfections in the phrase spoken.

### SUMMARY OF THE INVENTION

The subject matter of the invention is therefore a voice application system comprising means for acquiring at least one phrase spoken by at least one user connected to semantic analysis means comprising means for recognising keywords belonging to the phrase spoken and capable of generating an ordered list of keywords, called the listing, for the phrase spoken, these recognition means being connected to means providing an association in the form of rules between at least one predetermined keyword and a specific action or means for selecting at least one specific action when a set of keywords included in the corresponding rule are present in the phrase spoken, characterised in that the selection means run through all the rules for the purpose of identification and for each given rule seek out the presence of a set of keywords for that rule in the spoken phrase in order to select the corresponding specific action relating to the rule so determined and identified.

In accordance with other features of the invention:
the set of keywords for a rule comprises ordered sub-sets of keywords called expressions, each keyword or expression being combined with other keywords or expressions so that at least two keywords or expressions are either interchangeable, or present in a specific order of appearance, or again present in any order,
for a given rule comprising a set of expressions, the selection means select a corresponding action when the rule has been completely determined,
otherwise they search for the first keyword in the listing in the current expression and,
if the first keyword is found, they seek out the other keywords of the expression in the listing and
if this latter search is fruitless, the current expression is invalidated for this first keyword and the search is resumed,
otherwise the rule is determined and the corresponding action is selected, and if the first keyword is not found the search is resumed for the rest of the keywords,
the semantic analysis means also comprise branching means capable of determining the action which has to be executed from the set of actions selected.

### BRIEF DESCRIPTION OF THE DRAWINGS

This invention will be better understood from a reading of the following description which is provided purely by way of example with reference to the appended drawings in which:

FIG. 1 is a diagram of the invention as a whole,

FIG. 2 is a flow chart for a voice server using the invention,

FIG. 3 is a general flow chart for the invention, and

FIG. 4 is a detailed flow chart according to the invention for a rule.

### DETAILED DESCRIPTION OF THE PREFERRED EMBODIMENT

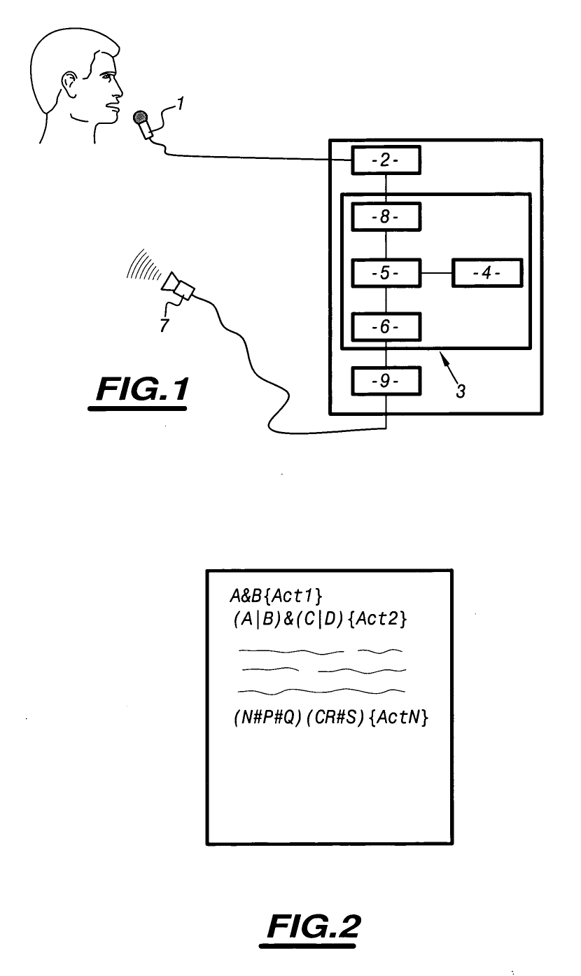

A voice application system according to the invention comprises, FIG. 1, means 1 for the acquisition of phrases spoken by a user.

Conventionally these acquisition means comprise a microphone, for example that in a telephone handset, connected to an electronic card which converts the analog signal generated by the microphone into a sequence of digital data which are representative of the signal received.

These acquisition means 1 are connected to voice recognition means 2.

These recognition means 2 use well-known technologies of the N-gram type in a conventional way. Companies such as Nuance and Scansoft market such technologies which are particularly suitable for continuous speech. Other voice recognition technologies may also be envisaged without this affecting the invention.

Voice recognition means 2 then transform the sequence of digital- data received from acquisition 1 into an unprocessed phrase.

Semantic analysis means 3, or the semantic analyser, comprise means 8 for the recognition of keywords which convert the unprocessed phrase into an ordered set of recognised or listed keywords.

They also comprise means 4 for association between keywords and actions. These association means are preferably in the form of rules of the type: <keyword 1> <keyword 2> . . . <keyword N>→action.

Semantic analysis means 3 also comprise selection means 5 which compare the ordered set of keywords recognised in the spoken phrase with the various rules 4. Rules 4 corresponding to the set of keywords thus define the set of potential actions which have to be carried out.

Semantic analyser 3 also comprises branching means 6. These branching means 6 are used when several rules have been selected in order to determine which rule's action should be executed.

Once the action has been selected, this is performed by dialogue means 9 which generate an appropriate phrase and transmit it to the user in response to the phrase which the latter spoke.

This phrase may be a reply or a question which can be used to refine the customer's expectations, and thus creates a dialogue between the user and the server.

The actions generated may also correspond to commands for an automatic system. For example a process control/command system may use a voice application system according to the invention to receive orders from an operator instead of or as a supplement to more conventional interfaces such as a keyboard and a screen.

The method of operation of semantic analyser 3 will now be described more particularly.

As previously indicated, each action is associated with a set of ordered keywords, the whole corresponding to one rule.

The set of rules, FIG. 2, is stored in the semantic analyser, for example in the form of a file. A preferential embodiment comprises collecting the rules in a text file which includes one rule per line.

The keywords are then ordered using three operators.

The first operator, denoted &, corresponds to the ordered AND operator. Thus A&B indicates that the keywords A and B must be present and that B follows A in the order of the listing.

The second operator, denoted #, corresponds to the non-ordered AND operator. A#B indicates that keywords A and B must be present and that the order in which A and B appear in the phrase is of no importance: AB and BA are recognised as belonging to this rule.

The third operator, denoted |, corresponds to the OR operator. A|B indicates that the listing must include one or other of A or B. The keywords A and B are therefore interchangeable.

These three operators can be combined together and brackets can be used to define groups of keywords.

For example (A|B) & (C#D) indicates that the rule is valid for a listing beginning with the keywords A or B followed by CD or DC.

In the preferred embodiment of the invention the action corresponding to the rule which has to be carried out is written at the end of the line, after the keywords, and is contained within brackets.

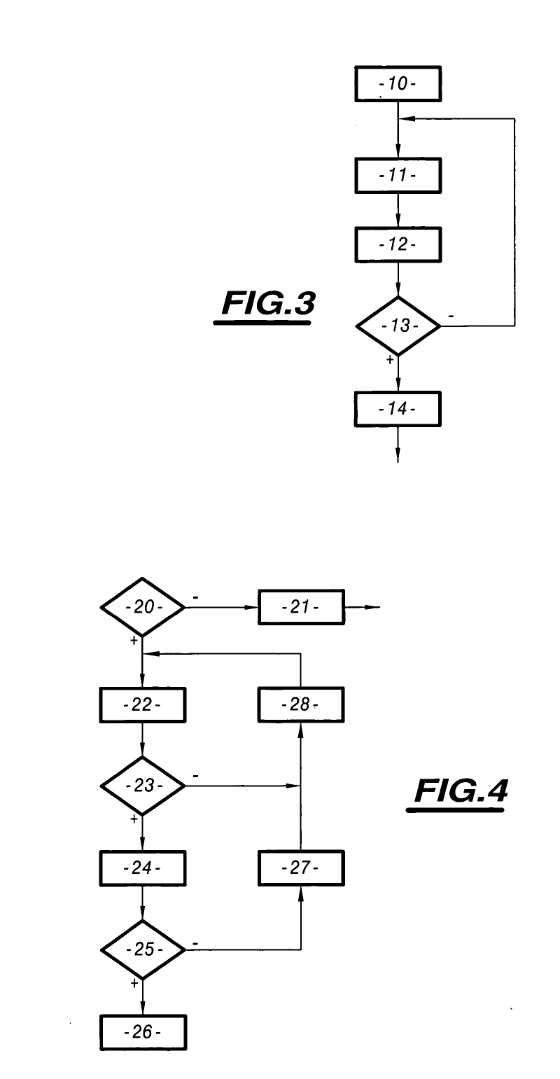

In stage 10, FIG. 3, semantic analyser 3 receives as an input a phrase in the form of an ordered sequence of keywords, or list, and has a set of rules in the form of a file.

It reads a first rule at 11 and seeks out the expected keyword for the latter. A rule is recorded as valid at 12 when the sequence of keywords which it defines is found in the listing.

However it may happen that the words expected in the rule are separated by other words unforeseen in the listing. These are then eliminated and are regarded as non-pertinent noise.

The semantic analyser nevertheless systematically attempts to check whether the phrase conforms with the rule.

Then having exhausted all possibilities for agreement or having discovered that the rule applies, the analyser seeks out the next rule at 13. If it exists it is analysed as before, otherwise the semantic analyser transmits the set of valid rules to branching means 6 at 14.

Thus in a particularly advantageous way semantic analyser 3 is able to ignore some keywords in the listing and consider anything lying between two expected words as non-determining information, i.e. noise.

In order to effect a full exploration of the possibilities of the listing with respect to the list of keywords in the rule the semantic analyser uses the following iterative procedure, FIG. 4:

1. If the expression has been fully determined at 20, there is a correct rule at 21 even if untested keywords remain,

2. If not it searches the 1^{st} word in the list of keywords at 22,

3. If the word is found at 23, a search is begun at 24 in the same way with the remainder of the keywords:
a. If the search of the rest of the keywords failed at 25, the subexpression which made it possible to find the 1^{st} word is invalidated at 27, for this 1^{st} word and that one only (it is regarded as noise) and the search is begun again. The final result is then the result of this new search.
b. If the search of the rest of the keywords is successful at 25, a correct rule is found at 26.

4. If the word is not found at 23, it is regarded as noise at 28 and a search of the remainder of the keywords is begun at 22. The final result is then the result of this new search.

This makes it possible to backtrack if a subexpression which was started fails and there are still alternatives in the rule which have not been explored.

In order to provide a better understanding of this operation, let us assume by way of example that the listing is
[Mobile] [Limit] [Amount] [Pay] [Reduction] [Pay] [Thing] [Expensive]
and the rule defines the expression
((Reduction # (Limit & Amount) # Pay & Expensive)) # Mobile)

The algorithm runs as follows:

1—search for the word [Mobile] in the expression, the search is successful.

2—successful search for [Limit], the subexpression [Limit & Amount] is started

3—search for [Amount] in the subexpression started, with success. The subexpression [Limit&Amount] is determined.

4—search for [Pay], with success and the subexpression [Pay&Expensive] is begun.

5—search for [Reduction] in the subexpression started. The search fails. [Reduction] is regarded as noise and it continues.

6—search for the 2^{nd} [Pay] in the subexpression started. The search fails again. The 2^{nd} [Pay] is regarded as being noise and it continues.

7—[Thing] is also not found in the expression begun. [Thing] is regarded as noise.

8—a search is made for the keyword [Expensive] in the expression started. The word [Expensive] is successfully found, but there are no more keywords and the expression has not been entirely determined. It then returns to point 7 with failure to determine the rule.

7.1—as [Thing] is not found, it returns to point 6.

6.1—as [Pay] is regarded as noise, it returns to point 5.

5.1—ditto for [Reduction], it returns to point 4.
4.1—as [Pay] is found, the subexpression [Pay&Expensive] is invalidated for the search for this first [Pay] but it remains accessible for the search for the 2^{nd} [Pay]. This subexpression is no longer regarded as having been begun. A search is again made for the 1^{st} [Pay] . This time the search fails because the subexpression [Pay&Expensive] is inaccessible. The 1^{st} [Pay] is regarded as noise and it continues.

5.2—search for [Reduction], which is found because no subexpression has been begun this time.

6.2—search for the 2^{nd} [Pay], which is found, and the subexpression [Pay&Expensive] is begun again.

7.2—search for [Thing], the search fails, it is therefore regarded as noise and it continues.

8.1—successful search for [Expensive]. The expression is fully determined and therefore it has been possible to find a correct rule.

Thus the invention makes it possible in a particularly advantageous way for the voice recognition system to recognise the rules which apply, despite noise and imperfections in the spoken phrase.

1. A voice application system comprising means for the acquisition of at least one phrase spoken by at least one user, connected to semantic analysis means comprising means for the recognition of keywords belonging to the phrase spoken and capable of generating an ordered list of keywords, called the listing, for the phrase spoken, the said recognition means being connected to means providing an association in the form of rules between at least one predetermined keyword and a specific action, and means for the selection of at least one specific action when a set of keywords included in the corresponding rule is present in the phrase spoken, characterised in that the selection means run through all the rules for the purpose of identification and for each given rule search for the presence of a set of keywords for that rule in the phrase spoken in order to select the corresponding specific action relating to the rule so determined and identified.

2. A voice application system according to claim 1, characterised in that the set of keywords for a rule comprises ordered subsets of keywords called expressions, each keyword or expression being combined with other keywords or expressions so that at least two keywords or expressions are either interchangeable, or present in a specific order of appearance, or are again present in any order.

3. A voice application system according to claim 2, characterised in that for a given rule comprising a set of expressions the selection means select the corresponding action when the rule has been completely determined, if not they search for the first keyword in the listing in the current expression and,
if the keyword is found, they search for the remainder of the keywords of the expression in the listing, and
if this latter search is fruitless, the current expression is invalidated for this first keyword and the search resumes,
otherwise the rule is determined and the corresponding action is selected, and if the first keyword is not found, the search is resumed for the remainder of the keywords.

4. A voice application system according to claim 1, characterised in that the semantic analysis means also comprise branching means capable of determining the action which has to be executed from the set of actions selected.

5. A voice recognition process comprising a prior step of effecting an association in the form of rules between at least one predetermined keyword and a specific action, and also comprising the stages of:
acquiring at least one phrase spoken by at least one user,
semantic analysis including a substage of recognition of the keywords belonging to the phrase spoken and a substage of generating an ordered list of the keywords, called a listing, for the phrase spoken, and
selecting at least one specific action when a set of keywords included in the corresponding rule is present in the phrase spoken,
characterised in that at the selection stage the entire set of rules is run through for the purposes of identification and a search is made for each given rule for the presence of a set of keywords for that rule in the phrase spoken to select the corresponding specific action relating to the rule so determined and identified.

6. A process according to claim 5, characterised in that the set of keywords for a rule comprises ordered subsets of keywords called expressions, each keyword or expression being combined with other keywords or expressions so that at least two keywords or expressions are either interchangeable, or are present in a particular order of appearance, or are present in any order.

7. Process according to claim 6, characterised in that for a given rule comprising a set of expressions, at the selection stage
the corresponding action is selected when the rule has been completely determined,
if not the first keyword in the listing is searched for in the current expression and,
if the first keyword is found, a search is made for the remainder of the keywords of the expression in the listing, and
if this latter search fails, the current expression is invalidated for that first keyword and the search resumes,
otherwise the rule is determined and the corresponding action is selected, and if the first keyword is not found, the search is resumed for the rest of the keywords.

8. A process according to claim 5, characterised in that the semantic analysis stage also comprises a substage of determining the action which has to be executed from the set of actions selected.

9. A computer program comprising program instructions designed to implement a voice recognition process according to claim 5 when the said programme is executed by an information technology system.

10. A computer-readable information substrate on which a computer program according to claim 9 is stored.
